(19) United States
(12) Patent Application Publication
(10) Pub. No.: US 2013/0030909 A1
(43) Pub. Date: Jan. 31, 2013

(54) CUSTOMIZABLE SOCIAL CAMPAIGNS

(71) Applicants: Clara Shih, San Francisco, CA (US); Steve Garrity, Palo Alto, CA (US); Roger Hu, Los Altos, CA (US); Yahui Jin, San Francisco, CA (US); Diana Freeman-Baer, Oakland, CA (US); Sean Conaty, San Francisco, CA (US); Kevin Zellmer, Moraga, CA (US); Jaleh Bisharat, Piedmont, CA (US); Julie Fortuna, Stanford, CA (US); Chris Andrew, San Francisco, CA (US)

(72) Inventors: Clara Shih, San Francisco, CA (US); Steve Garrity, Palo Alto, CA (US); Roger Hu, Los Altos, CA (US); Yahui Jin, San Francisco, CA (US); Diana Freeman-Baer, Oakland, CA (US); Sean Conaty, San Francisco, CA (US); Kevin Zellmer, Moraga, CA (US); Jaleh Bisharat, Piedmont, CA (US); Julie Fortuna, Stanford, CA (US); Chris Andrew, San Francisco, CA (US)

(73) Assignee: HEARSAY LABS, INC., San Francisco, CA (US)

(21) Appl. No.: 13/555,759

(22) Filed: Jul. 23, 2012

Related U.S. Application Data
(60) Provisional application No. 61/511,669, filed on Jul. 26, 2011.

(51) Int. Cl. G06Q 30/02

(52) U.S. Cl. 705/14.48; 705/14.4

(57) ABSTRACT

Managing social network-based marketing campaigns includes obtaining, using one or more computer processors, a social media network-based marketing campaign and configuration information associated with the social media network-based marketing campaign; and publishing the plurality of selected publishable elements on the social media platform, according to the configuration information. The social media network-based marketing campaign comprises a plurality of selected publishable elements that are selected from a collection of master publishable elements. The master publishable elements are publishable on a social media platform. The configuration information at least includes information on how the plurality of selected publishable elements are to be published on the social media platform.

### CROSS REFERENCE TO OTHER APPLICATIONS

This application claims priority to U.S. Provisional Patent Application No. 61/511,669 entitled CUSTOMIZABLE SOCIAL CAMPAIGNS filed Jul. 26, 2011 which is incorporated herein by reference for all purposes.

### BACKGROUND OF THE INVENTION

Social media has become an important way for online users to connect with each other, create content, and exchange information. As social media platforms such as Facebook®, Twitter®, LinkedIn®, etc. become more popular, many businesses are becoming interested in leveraging social media for marketing purposes. As used herein, marketing, advertising, publicity, or any other promotional activities aimed at increasing awareness of a company and/or its products/services and/or getting potential buyers to make purchases are collectively referred to as marketing. Social media-based marketing campaigns present new opportunities and challenges.

### BRIEF DESCRIPTION OF THE DRAWINGS

Various embodiments of the invention are disclosed in the following detailed description and the accompanying drawings.

FIG. 1 is a functional diagram illustrating a programmed computer system for managing social networking-based marketing campaigns in accordance with some embodiments.

FIG. 2 is a block diagram illustrating an embodiment of a system configured to manage social networking-based marketing campaigns.

FIG. 3A is a diagram illustrating an embodiment of a data structure of a content library.

FIG. 3B is a diagram illustrating an example of a configured social media network-based marketing campaign.

FIG. 4 is a flowchart illustrating an embodiment of a process for creating a collection of publishable elements.

FIG. 5 illustrates an example content library for posts.

FIGS. 6-7 illustrate example user interface templates used to create a new publishable post element.

FIGS. 8 and 9 illustrate the creation process of an ad.

FIG. 10 illustrates an example ad library, where existing ads can be displayed and searched by the publisher.

FIG. 11 illustrates an example of an applications (apps) library.

FIG. 12 is a diagram illustrating an embodiment of a configuration interface for a specific tab, “RSS Feed.”

FIG. 13 is a flowchart illustrating an embodiment of a process for publishing a social network-based marketing campaign.

FIGS. 14-22 are example UI screens illustrating the creation of a social campaign.

FIG. 23 shows the budget configurations for an ad element.

FIG. 24 is an example of a social media asset on which the campaign is published.

FIG. 25 is an example screen showing audit settings.

FIGS. 26-27 are example screenshots illustrating results of the compliance approval process.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Creating flexible and easily manageable marketing campaigns for social media platforms is disclosed. In some embodiments, a campaign management platform includes a collection of publishable master elements, created by one or more creators (such as a corporate marketer in charge of the overall corporate marketing strategy or an authorized individual contributor), and can be published on one or more social media platforms. As used herein, social media platforms refer to networked platforms (e.g., websites) that allow users to generate content and communicate with one another, such as Facebook®, Twitter®, LinkedIn°, Google+®, etc. The publishable elements include different types of content that can be published on the social media platforms (e.g., Facebook® posts, Twitter® tweets, etc.) Auditing functions are provided to make sure that the publishable master elements conform to corporate standards and regulations. Authorized publishers (such as regional representatives of the same corporation) are allowed to access and customize the master element according to their needs and publish the customized elements to various social media platforms. In some embodiments, the creator can create a variety of master elements, such as advertisements (also referred to as ads), posts, sponsored stories (also referred to as sponsored feeds), applications (also referred to as apps/tabs), deals, etc., which can be deployed by the publishers in marketing campaigns, sometimes in a coordinated fashion. Master elements can include content such as text, links, photos, audio, and video. Some require special formatting (e.g., some posts must not exceed certain character length); some will cost money (e.g., the social media site charges for ads or sponsored stories). For example, a series of ads, posts, and deals for marketing a certain product can be published over time or based on certain triggering events, to a social media asset controlled by the publisher, in a way that the publisher believes would be most effective. As used herein, a social media asset refers to the personal or professional presences of a user on various social networking sites or elsewhere (e.g., a Facebook® page, a Twitter® account, a LinkedIn® profile, a Google+® account, etc.). Statistics relating to the published campaign are optionally fed back so the campaign can be improved. The platform gives the corporation a great degree of control over the content that is publishable, and at the same time gives publishers flexibility over how a marketing campaign should be run and simplifies the process for carrying out a campaign.

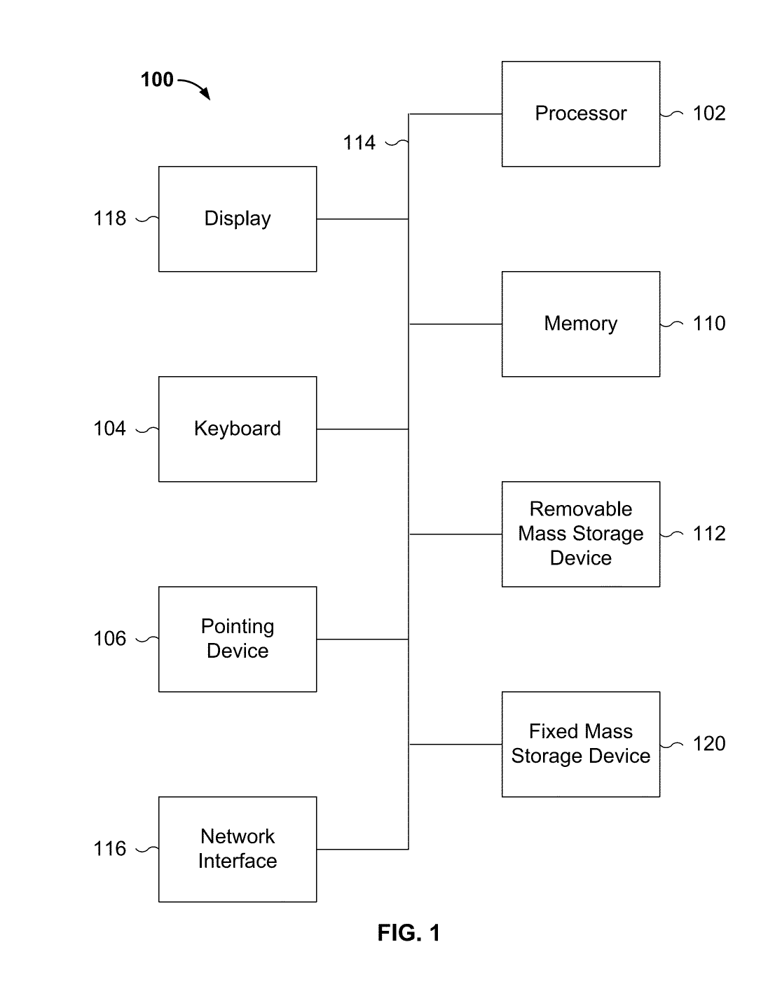

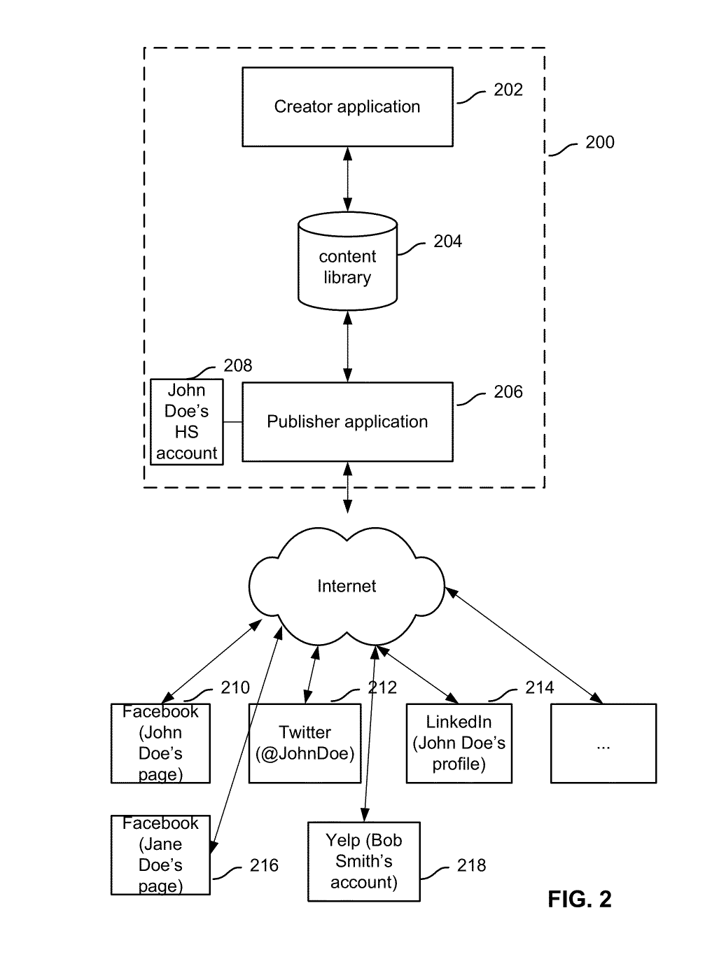

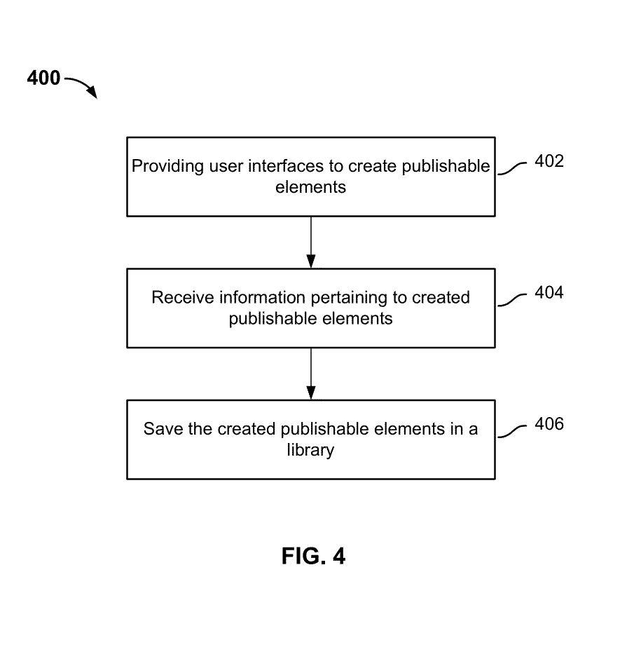

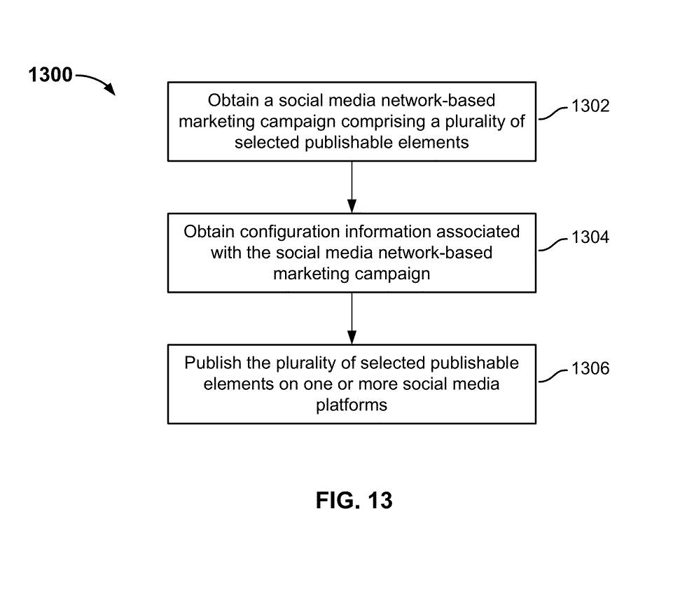

FIG. 1 is a functional diagram illustrating a programmed computer system for managing social networking-based marketing campaigns in accordance with some embodiments. As shown, FIG. 1 provides a functional diagram of a general purpose computer system programmed to perform social networking-based marketing campaign management in accordance with some embodiments. As will be apparent, other computer system architectures and configurations can be used to perform context-sensitive script editing for form design. Computer system 100, which includes various subsystems as described below, includes at least one microprocessor subsystem (also referred to as a processor or a central processing unit (CPU)) 102. For example, processor 102 can be implemented by a single-chip processor or by multiple processors. In some embodiments, processor 102 is a general purpose digital processor that controls the operation of the computer system 100. Using instructions retrieved from memory 110, the processor 102 controls the reception and manipulation of input data, and the output and display of data on output devices (e.g., display 118). In some embodiments, processor 102 includes and/or is used to provide the various computer/computer implemented functional elements described below with respect to FIG. 2 and/or executes/performs the process described below with respect to FIGS. 4 and 13.

Processor 102 is coupled bidirectionally with memory 110, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as is well known in the art, primary storage typically includes basic operating instructions, program code, data and objects used by the processor 102 to perform its functions (e.g., programmed instructions). For example, primary storage devices 110 can include any suitable non-transitory computer readable storage media, described below, depending on whether, for example, data access needs to be bidirectional or unidirectional. For example, processor 102 can also directly and very rapidly retrieve and store frequently needed data in a cache memory (not shown).

A removable mass storage device 112 provides additional data storage capacity for the computer system 100, and is coupled either bidirectionally (read/write) or unidirectionally (read only) to processor 102. For example, storage 112 can also include computer-readable media such as magnetic tape, flash memory, PC cards, portable mass storage devices, holographic storage devices, and other storage devices. A fixed mass storage device 120 can also, for example, provide additional data storage capacity. The most common example of mass storage 120 is a hard disk drive. Mass storage 112, 120 generally store additional programming instructions, data, and the like that typically are not in active use by the processor 102. It will be appreciated that the information retained within mass storage 112, 120 can be incorporated, if needed, in standard fashion as part of primary storage 110 (e.g., RAM) as virtual memory.

In addition to providing processor 102 access to storage subsystems, bus 114 can be used to provide access to other subsystems and devices as well. As shown, these can include a display monitor 118, a network interface 116, a keyboard 104, and a pointing device 106, as well as an auxiliary input/output device interface, a sound card, speakers, and other subsystems, as needed. For example, the pointing device 106 can be a mouse, stylus, track ball, or tablet, and is useful for interacting with a graphical user interface.

The network interface 116 allows processor 102 to be coupled to another computer, computer network, or telecommunications network using a network connection, as shown. For example, through the network interface 116, the processor 102 can receive information (e.g., data objects or program instructions), from another network, or output information to another network in the course of performing method/process steps. Information, often represented as a sequence of instructions to be executed on a processor, can be received from and outputted to another network. An interface card or similar device and appropriate software implemented by (e.g., executed/performed on) processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Additional mass storage devices (not shown) can also be connected to processor 102 through network interface 116.

An auxiliary I/O device interface (not shown) can be used in conjunction with computer system 100. The auxiliary I/O device interface can include general and customized interfaces that allow the processor 102 to send and, more typically, receive data from other devices such as microphones, touch sensitive displays, transducer card readers, tape readers, voice or handwriting recognizers, biometric readers, cameras, portable mass storage devices, and other computers.

In addition, various embodiments disclosed herein further relate to computer storage products with a computer readable medium that includes program code for performing various computer-implemented operations. The computer readable medium is any data storage device that can store data which can thereafter be read by a computer system. Examples of computer readable media include, but are not limited to: all the media mentioned above, magnetic media such as hard disks, floppy disks, and magnetic tape, optical media such as CD-ROM disks, magneto-optical media such as optical disks, and specially configured hardware devices, such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized (e.g., server devices, appliances with hardware configured for specific functions, such as a web server or an application server, and/or various other types of computing devices that can execute various operating systems and/or virtual machine software techniques).

FIG. 2 is a block diagram illustrating an embodiment of a system configured to manage social networking-based marketing campaigns. In some embodiments, the system is implemented on a marketing campaign management platform 200 that supports the Software as a Service (SaaS) model, and allows authorized users to interact with its applications over a network. As shown, marketing campaign management platform 200 includes a creator application 202, a content library 204, and a publisher application 206.

A creator, typically a corporate level user who is authorized to create social media network-based marketing campaigns (also referred to as campaigns), to be deployed by publishers (such as regional level users), has access to a creator application 202 and uses the creator application to create master campaign elements (also referred to as collaterals) such as ads, posts, sponsored stories, tabs, deals, and/or a variety of items that can be published and integrated into various social networking sites. Each campaign element can include original content or imported content. The creator can also configure properties associated with the campaign elements, such as timing information pertaining to when a specific element should be published. In some embodiments, the creator can also configure an integrated campaign that includes a plurality of campaign elements, and customize the default settings of the integrated campaign. Further details of how to create the content library are described below.

The master campaign elements are stored in a content library 204 (e.g., as objects or entries in a database). Additional data about the master campaign elements, such as metadata pertaining to their configuration and deployment, can also be stored in the content library. The content library includes a collection of master campaign elements available to be published in social media network-based marketing campaigns. A publisher can access the content library through a publisher application 206. The publisher application provides interfaces that allow the publisher to locate and select a campaign or a set of campaign elements of interest. The publisher application further gives the publisher options to configure and customize certain aspects that are deemed to be configurable by the creator (e.g., timing of when each element should be published or triggering events for publishing certain events), or to simply use the preset defaults. The configuration information is stored, and is used by the publisher application to publish the selected campaign elements. In some embodiments, the publisher application publishes the selected campaign elements to one or more social media platforms using Application Programming Interfaces (APIs) provided by the social media platforms (such as the Facebook® Graph API), according to the timing interval or sequence specified by the configuration. Further details of the publisher application are also described below.

In some embodiments, the campaign management platform implements a single sign-on feature. As shown in this example, when a publisher such as a regional representative (e.g., John Doe) initially signs up with the marketing campaign management platform, a user account (John Doe's Hearsay Social Account 208) is established on the platform. Via user interface provided by the platform, the publisher associates a number of social networking assets with his account on the marketing campaign management platform. Examples of the social networking assets include John Doe's Facebook® page 210, Twitter® account 212, LinkedIn®profile 214, the accounts of his associates/employees/people linked to him on the social media platform provided that authorization is given (such as Jane Doe's Facebook® page 216, Bob Smith's Yelp® account 218), etc. In some embodiments, the association is made by providing credentials (e.g., account name and password) associated with the social networking assets to the campaign management platform (e.g., the creator/publisher applications), which saves the information and establishes connections to the social networking assets. This way, once the publisher selects to publish selected campaign elements (or a campaign comprising selected elements,) the publisher application will send the elements to various social networking assets using, for example, APIs provided by the social networking sites, without requiring the publisher to logon to the individual accounts. In some embodiments, the publisher application includes connectors that format the campaign elements and transfer the formatted data to the preconfigured social networking assets during publication.

In some embodiments, the marketing campaign management platform provides expanded administration access to the district level with customizable hierarchies, roles, and entitlements. This empowers district managers to deliver more relevant and localized content to their field reps and branches. It also lets them roll up and analyze results by region and sub-region, thus providing an important service for managers with profit and loss responsibilities. In the discussions below, a hierarchy involving one or more corporate creators at the highest level and one or more publishers at a lower, regional level is described for purposes of example. The higher level users have greater access and privileges to edit and manage the content of the marketing materials than the lower level users. Other hierarchical arrangements are possible on the marketing campaign platform for other embodiments.

### Creation of Publishable Elements

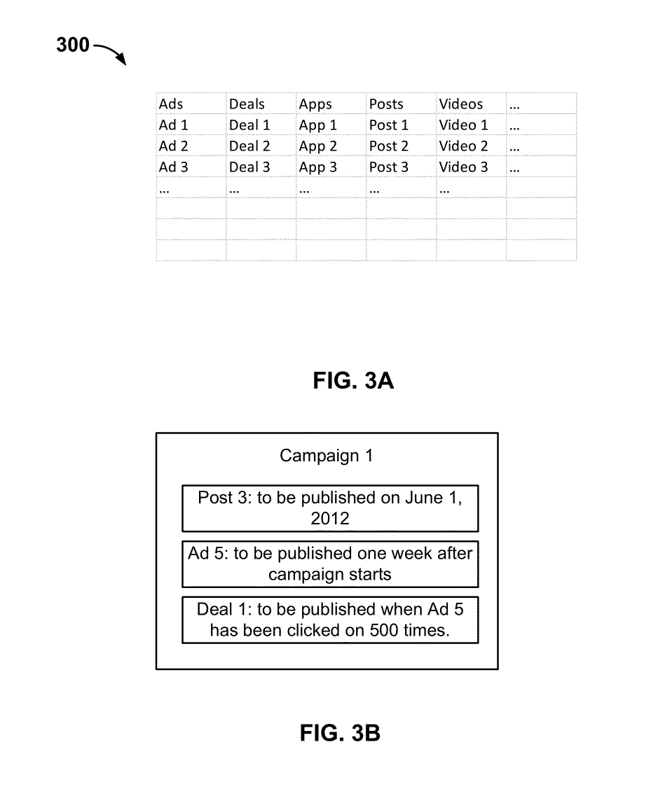

FIG. 3A is a diagram illustrating an embodiment of a data structure of a content library. In some embodiments, the content library is a database storing master publishable elements. The master publishable elements have appropriate formats as required by one or more social media platforms and can be published on the social media platforms. In the example shown, content library 300 includes a number of categories based on the types of publishable elements, such as ads, posts, tweets, sponsored stories, applications, blog posts, deals, messages, or any other appropriate data that can be incorporated into social networking platforms. Each type of publishable element includes information that is encoded for submission to the social media platforms, which publishes the information by making it available for display or download via an application (e.g., a web browser, a mobile application, or the like). Subcategories and/or different categorization schemes are possible. In some embodiments, the publishable elements can include keywords, identifiers, or any other appropriate data to facilitate searches.

The elements stored under each category can have original content created by the creator using the creator application, as well as imported content from other sources. In some embodiments, to obtain imported content, the creator application monitors the various social networking assets and identifies any published content that pertains to the company and that is particularly popular. For example, the creator application monitors the social media assets that are identified by the publisher, as well as other potentially related social media assets (e.g., Facebook® pages, Twitter® feeds, etc. of people who have identified themselves as the employees of the company, even though their accounts are not necessarily linked to the publisher's campaign platform account). Popular content is identified (e.g., a Facebook® posting that includes the company name and received a certain number of “Likes,” a tweet with the company name as a hash tag and that has received a certain number of “Favorites,” etc.). In some embodiments, the creator application allows the creator to import the popular content into the library. In some embodiments, a publisher can also identify any suitable content and recommend it to the creator for adding the content to the library.

FIG. 4 is a flowchart illustrating an embodiment of a process for creating a collection of publishable elements. Process 400 can be implemented on a system such as 100 or 200. In some embodiments, process 400 is used to implement the creator application. The process initiates when the creator logs on to the marketing campaign management platform to access a content library in which various publishable elements are stored. The elements include advertisements (ads), posts, tweets, sponsored stories, applications (apps/tabs), blog posts, deals, messages, or any other appropriate data that can be incorporated into social networking platforms. Each type of element can have its own format, and optionally a set of associated metadata. For example, an ad may include a picture, a slogan, and a keyword; a post may include some text and a URL. The publishable elements can be filtered for viewing based on category, most recently accessed, most popular, and any other appropriate filtering parameters.

At 402, UIs and associated functions are provided to a creator to create or modify master publishable elements. For example, in some embodiments, templates are provided for creating or modifying the elements. Detailed examples of the user interfaces are describe below. At 404, information pertaining to newly created or modified publishable elements is received. For example, the creator can use the creator application and its UIs to enter or modify ads, posts, sponsored stories, tweets, applications (tabs), blog posts, deals, messages, or any other appropriate data that can be incorporated into social networking platforms. The data obtained via the UIs is used to create or update objects or other data structures that correspond to the publishable elements. At 406, the created or modified publishable elements are stored in a library of master publishable elements. The library can be implemented as a database or other appropriate data structure. The master publishable elements are later selectively used by a publisher to form a social media network-based marketing campaign. A master publishable element can be reused in multiple social media network-based marketing campaigns. In some embodiments, a copy of the master publishable element is created and included in a campaign so that the publisher can make modifications to the copy without affecting the master element.

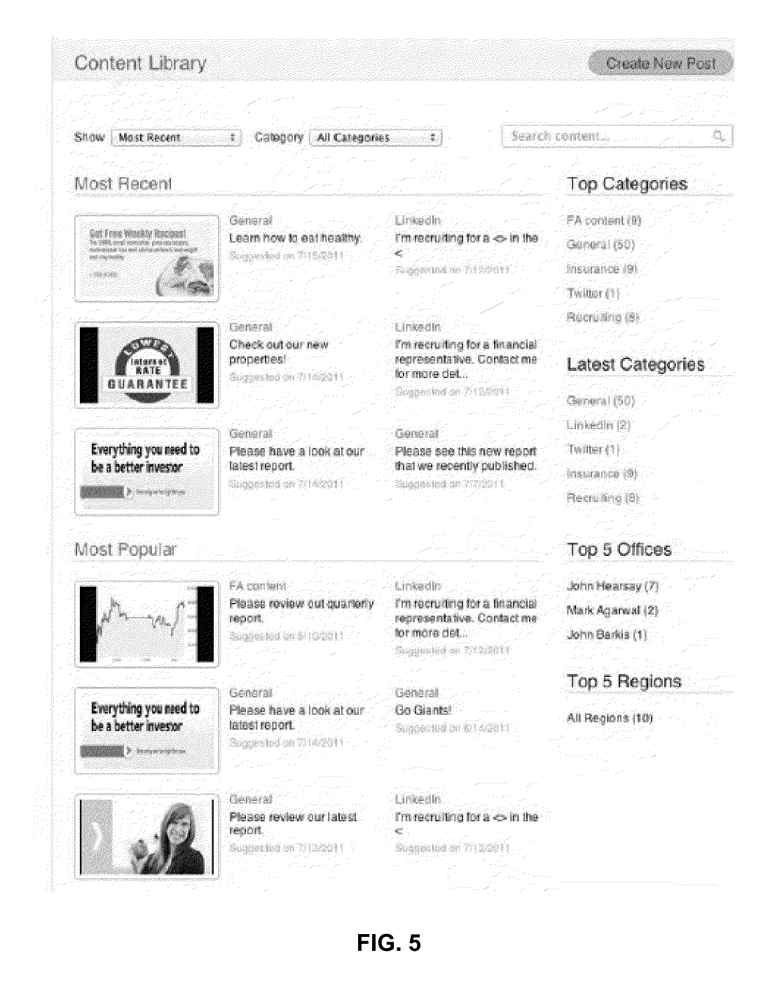

FIGS. 5-12 are example screenshots illustrating embodiments of UIs for creating publishable elements. The UIs shown in this example are implemented as a part of the creator application. UIs for posts, ads, and applications are disclosed, and other similar UIs can be implemented for other types of publishable elements.

FIG. 5 illustrates an example content library for posts. The creator can view existing posts in the library by specifying a “show” option, which can be set to show the most recently added posts, the most popular posts, etc. The display can be organized in different ways, such as a list view of all the posts. In this example, the creator can select the “create new post” button to start creating a new post element.

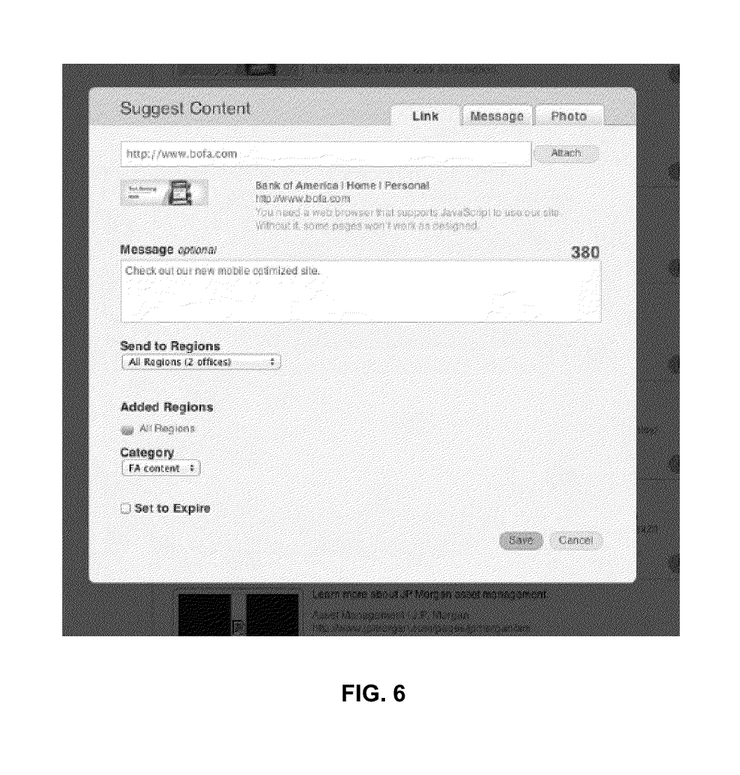

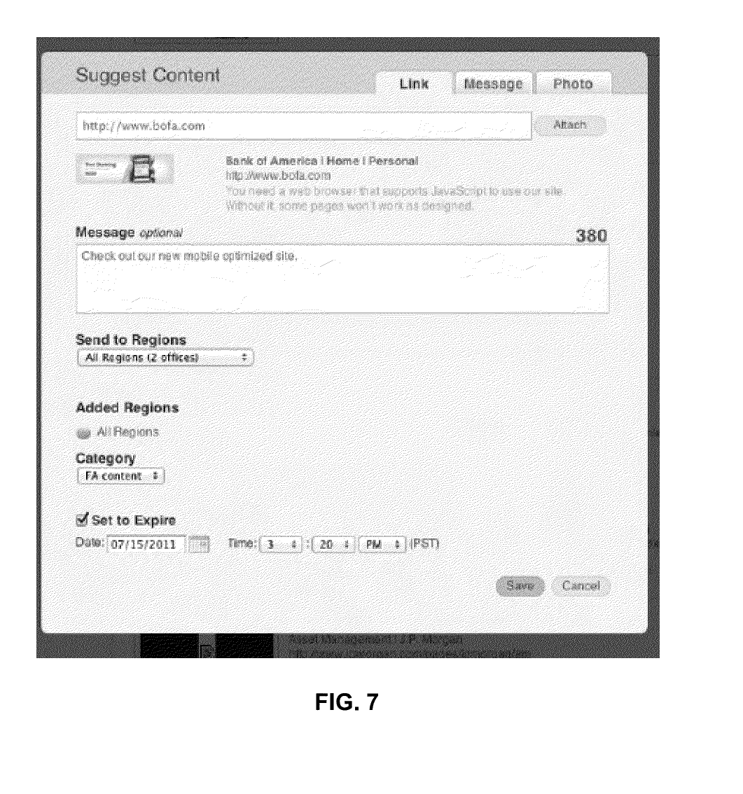

FIGS. 6-7 illustrate example user interface templates used to create a new publishable post element. As shown in FIG. 6, the template includes a “suggest content” box, which allows the creator to suggest/create a new post for the publisher to post to selected social networking platforms such as Facebook®, LinkedIn®, Twitter®, Google+®, etc. As shown in FIGS. 6 and 7, the creator can attach a URL to the post and optionally add a message. The system pulls information such as a title, a summary, a thumbnail image, etc., from the URL and incorporates the information into the post. Optionally, the creator can also include photos, audios, videos, etc. in the post. The creator application can suggest content to be added in the post by the creator, such as the URL to be used, the message to be displayed, etc. The creator can then save the post element.

In some embodiments, an element includes additional attributes such as region targeting information and an effective period. For example, an element can be specified to only be valid in certain states, and can be set to expire after a certain time. In the example shown in FIG. 7, it is assumed that the corporate administrator has already configured different regions in which the corporation's agents are located. For example, a hierarchy of country/geographical region/state/city may be set up and the creator can select all or a subset of the corporate regions to participate in the campaign. In this example, the creator has selected the target region to be “all regions.” The creator can also configure the category to which the post belongs (such as arts, entertainment, sports, etc.), and the effective time period during which the post can be active. Further, the creator can specify which parts of the element are customizable by the publisher. For example, the creator may decide that the text portion of a post is customizable but the URL is not.

In some embodiments, the region information and the effective time information is considered to be default information, and the configured campaign information is bundled and stored in the content library, which is made available to local users (publishers) in targeted regions. In some embodiments, the element-specific region and effective period can be overwritten by campaign-specific information. In other words, if a region and/or effective period are specified in a campaign, then the region and/or effective period specified at the level of individual elements is ignored, and the campaign-specific region and/or effective period is applied to the elements instead.

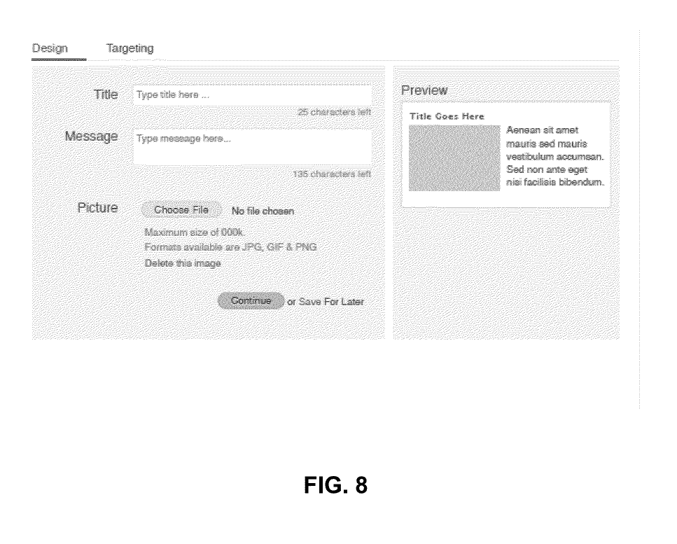

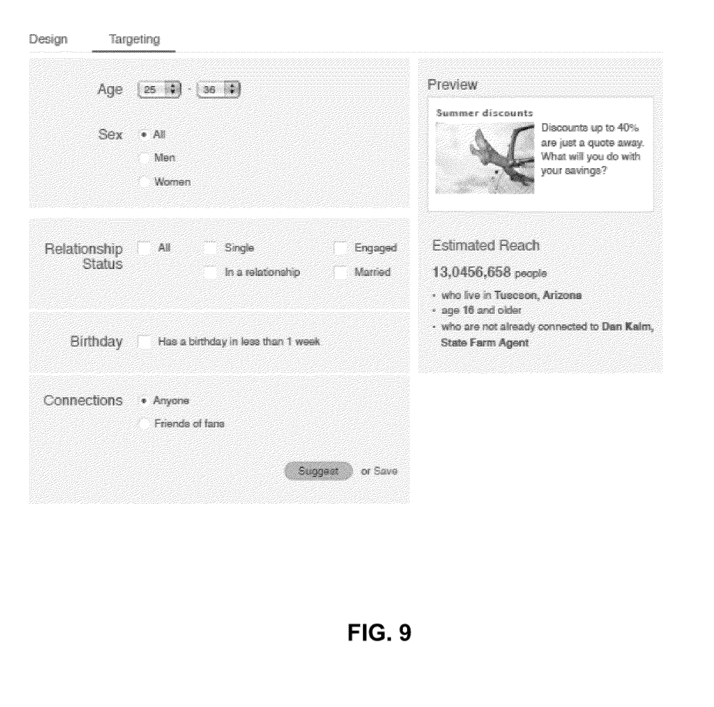

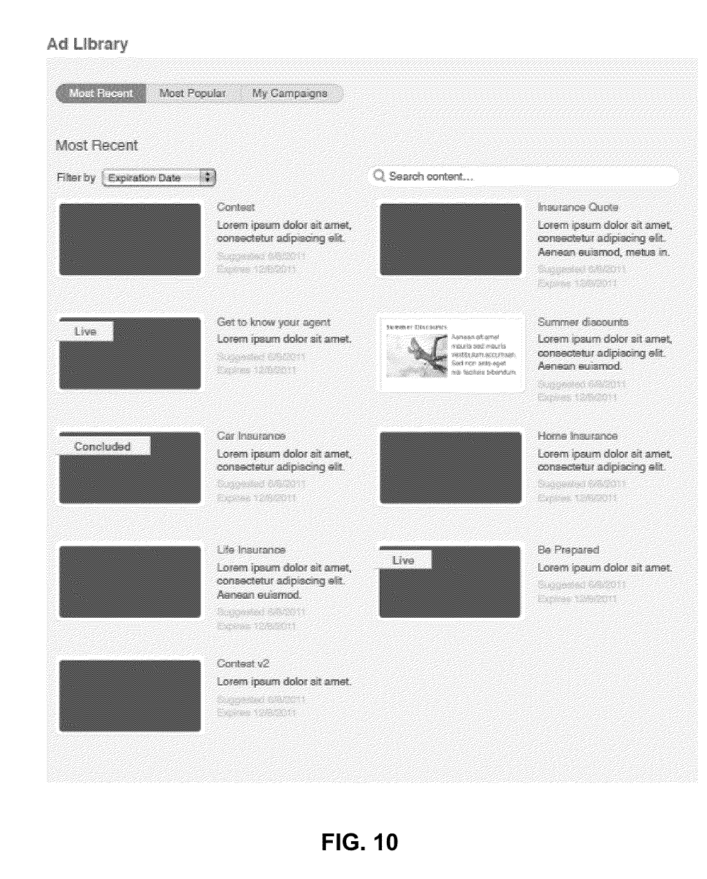

Advertisements (ads) are another type of publishable elements. FIGS. 8 and 9 illustrate the creation process of an ad. FIG. 8 shows an example template for designing an ad. The title, message, and picture associated with the ad are added to the template. Additional resources, such as audio/video or other appropriate data can be included in other embodiments. Since many social networking platforms allow ads to be displayed to targeted audience, ad targeting is configured at this stage. FIG. 9 shows the example configuration options for configuring the audience targeted by the ad. Via functional tools such as APIs provided by the social networking site designated to display the ad (e.g., the “estimated reach” API by Facebook®), options pertaining to the ad are presented to the publisher for editing. In this example, the options include the age, sex, relationship status of the targeted audience, birthday proximity, and how the targeted person is connected to the publisher. FIG. 10 illustrates an example ad library, where existing ads can be displayed and searched by the publisher.

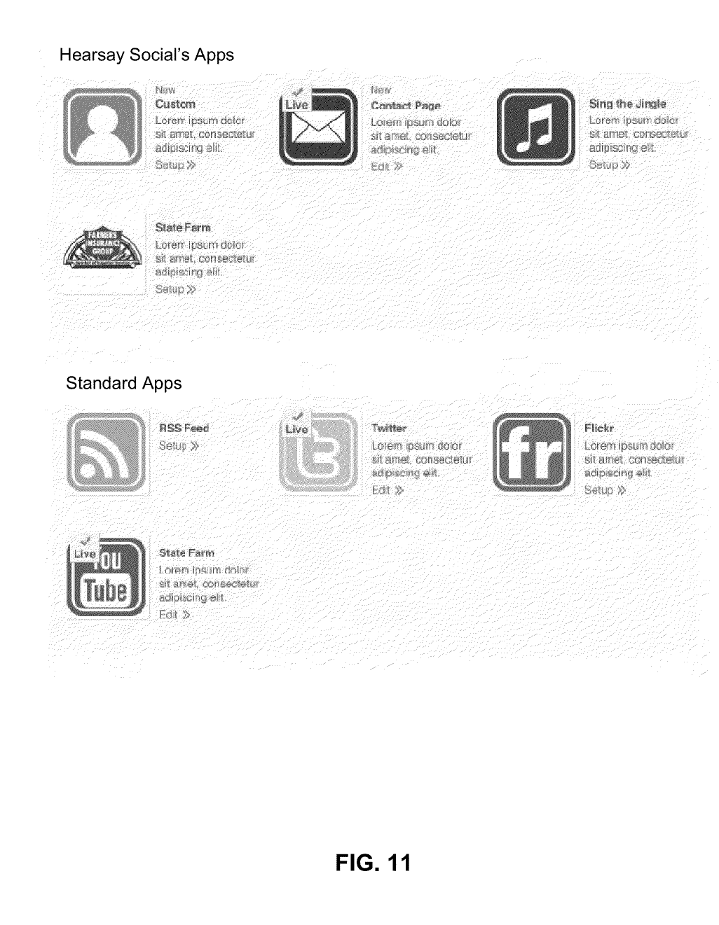

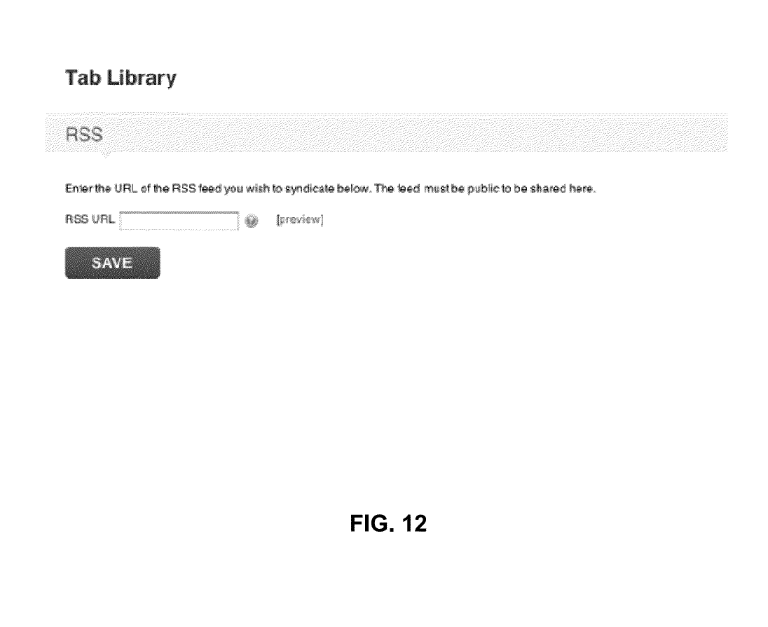

Applications (also referred to as apps or tabs) are another type of publishable elements. For example, platforms such as Facebook® allow certain applications to be added to a user's page. FIG. 11 illustrates an example of an applications (apps) library. Both custom apps for the particular corporate customer (listed under Hearsay Social's Apps) and standardized tabs that are available to all customers of the platform (listed under Standard Apps) are displayed. FIG. 12 is a diagram illustrating an embodiment of a configuration interface for a specific tab, “RSS Feed.”

Many other types of campaign elements may be created and stored by the creator and used by the publisher. Since different social networking sites may accept different types of elements with different technical and/or stylistic requirements (e.g., different text lengths, different picture formats), the platform offers different configuration options during the creation/publication process to conform to the requirements of different sites.

### Publishing and Managing the Campaign

The created elements are saved in the content library. Using the publisher application, the publisher (e.g., a regional manager of the corporation who is interested in launching a social media network-based marketing campaign on the company's behalf) can access the saved element, customize certain elements that the creator has indicated as customizable, and construct a social media network-based marketing campaign to be published on social media platforms.

FIG. 13 is a flowchart illustrating an embodiment of a process for publishing a social network-based marketing campaign. Process 1300 can be executed on a system such as 200. At 1302, a social media network-based marketing campaign is obtained. The social media network-based marketing campaign includes a plurality of selected publishable elements that are selected from a collection of publishable elements. In some embodiments, the selected publishable elements are chosen from the content library by a publisher using a tool such as the publisher application. In some embodiments, default campaigns comprising pre-selected publishable elements are available for selection by the publisher. Referring to FIG. 3B, an example of a social media network-based marketing campaign includes “Ad 5,” “Post 3,” and “Deal 1.”

Returning to FIG. 13, at 1304, configuration information associated with the social media network-based marketing campaign is also obtained. In some embodiments, the platform supports integrated campaigns where the creator configures a default campaign that is used by the publisher without modification. In such cases, the configuration information is obtained along with the campaign information, without necessarily requiring a separate step. In some embodiments, the configuration information is obtained from the publisher. The configuration information specifies how the selected publishable elements in the campaign are to be published on one or more social media platforms. The configuration information can include sequencing information (e.g., the order in which the publishable elements are published, absolute or relative time at which each publishable element is published, and/or events that trigger the respective elements to be published), budget information (e.g., how much money can be spent on publishing an ad element, a sponsored feed, or other elements that cost money), and any other appropriate information.

For example, the publisher can select, from the library, a post about a certain problem, an ad describing a product solving the problem, and a deal for purchasing the product. He can configure the elements in such a way that the post is published on the first day on his Facebook® page and in his Twitter® feed, the ad is displayed on these accounts one week later, and the deal is shown after the ad has been viewed (e.g., clicked on by users) a certain number of times. FIG. 3B is a diagram illustrating an example of a configured social media network-based marketing campaign. In the diagram shown, the first publishable element, “Post 3,” has an absolute timing condition and is to be published on Jun. 1, 2012. The second publishable element, “Ad 5,” has a relative timing condition specifying that the ad is to be published one week after the first element is published. The third publishable element, “Deal 1,” is triggered by an event; specifically, the deal is to be published in the event that “Ad 5” has been clicked on 500 times by users.

Returning to FIG. 13, at 1306, the selected publishable elements are published on one or more social media platforms, according to the configuration information. In the example of FIG. 3B, each publishable element is published (e.g., posted to the appropriate social networking platform) when a configured condition for publication is met. Examples of the condition include time, triggering events (e.g., when 500 users have signed on to a service), etc.

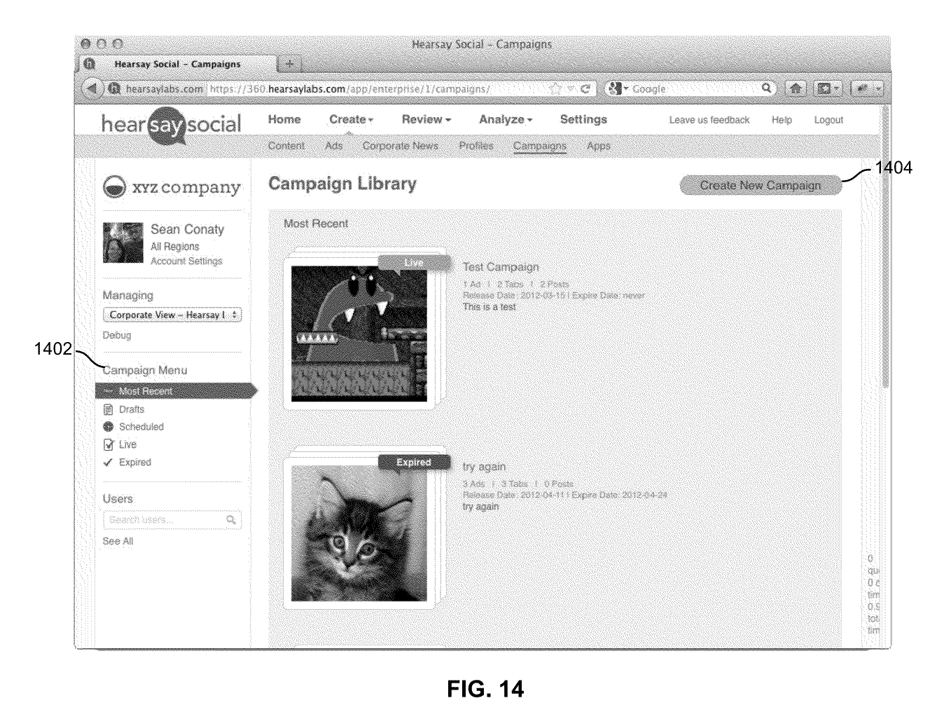

FIGS. 14-22 are example UI screens illustrating the creation of a social campaign.

FIG. 14 displays existing campaigns, expired campaigns and creating new campaigns. The publisher is provided with a campaign menu 1402 to view existing campaigns, and a “Create New Campaign” button 1404 to create a new campaign.

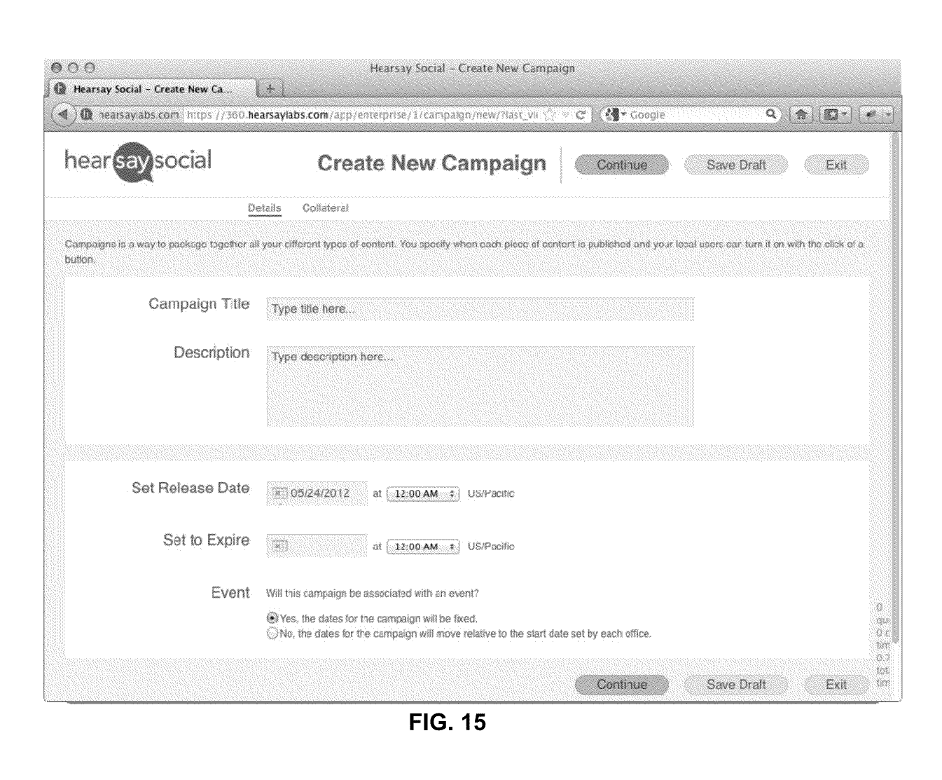

FIG. 15 is an example UI screen showing an example campaign creation template. Information about a new campaign is entered into the template. The publisher is provided with user interfaces to enter the title and description of the campaign, to set the release date and the expiration date, and to set whether the campaign should be associated with any event. There are many possibilities of events. In this case, the event is time-based and the publisher can choose whether to set fixed dates, or use dates relative to the start date set by each office.

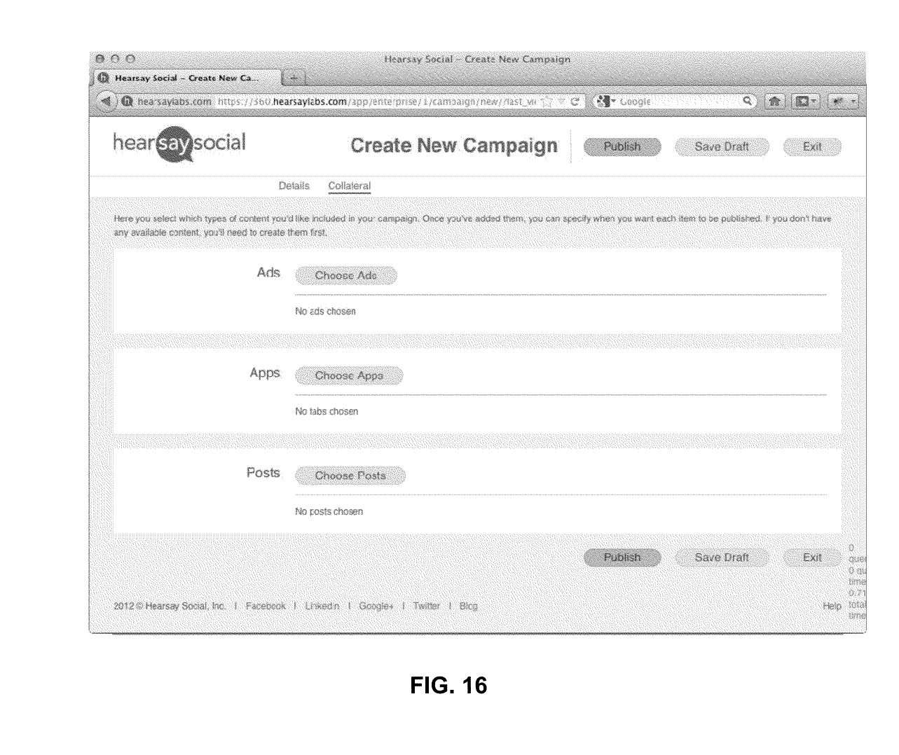

In FIG. 16, the publisher is provided with user interfaces to add different types of publishable elements (referred to as collaterals in the diagram). As shown in the example, the publisher can choose ads, applications (apps), or posts by selecting “Choose Ads,” “Choose Apps,” or “Choose Posts” buttons. Other/additional UIs for choosing other types of publishable elements (such as deals, photos, videos, etc.) can be provided in other embodiments.

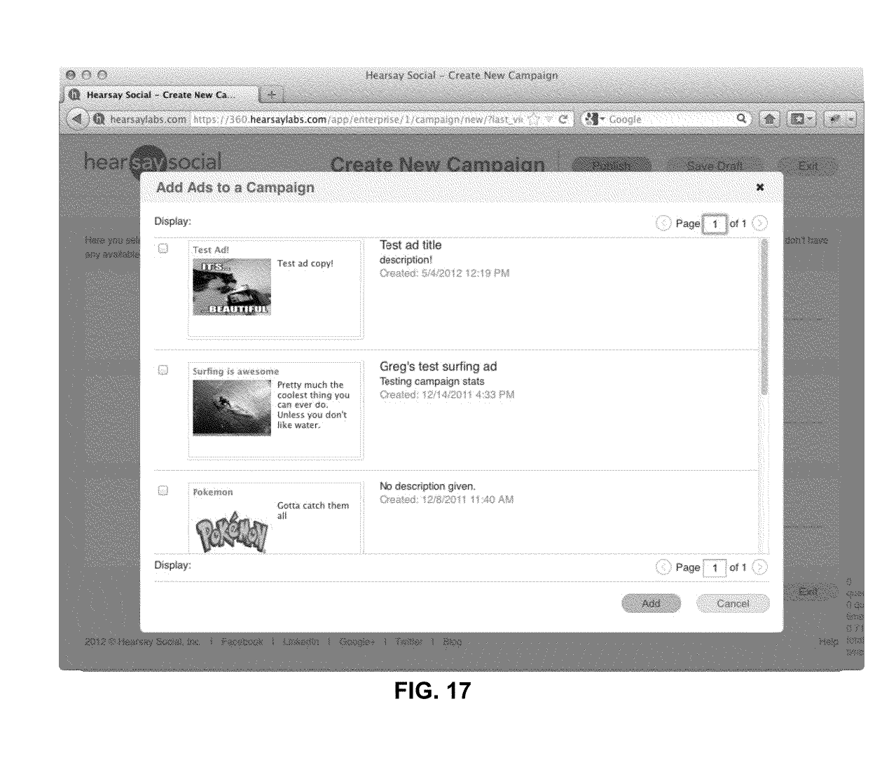

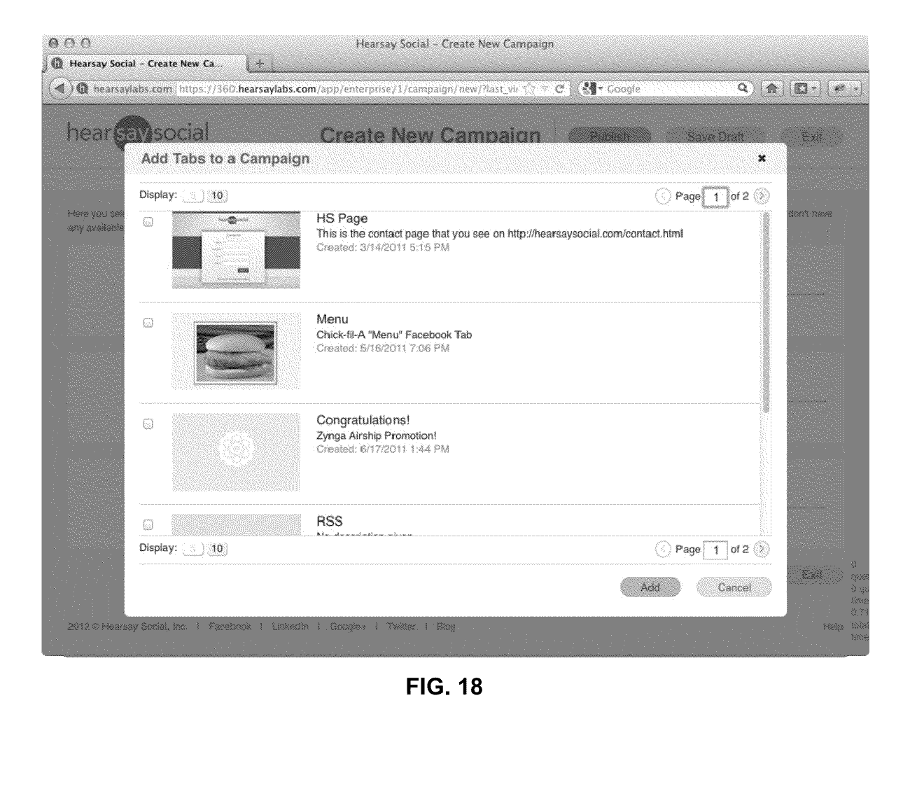

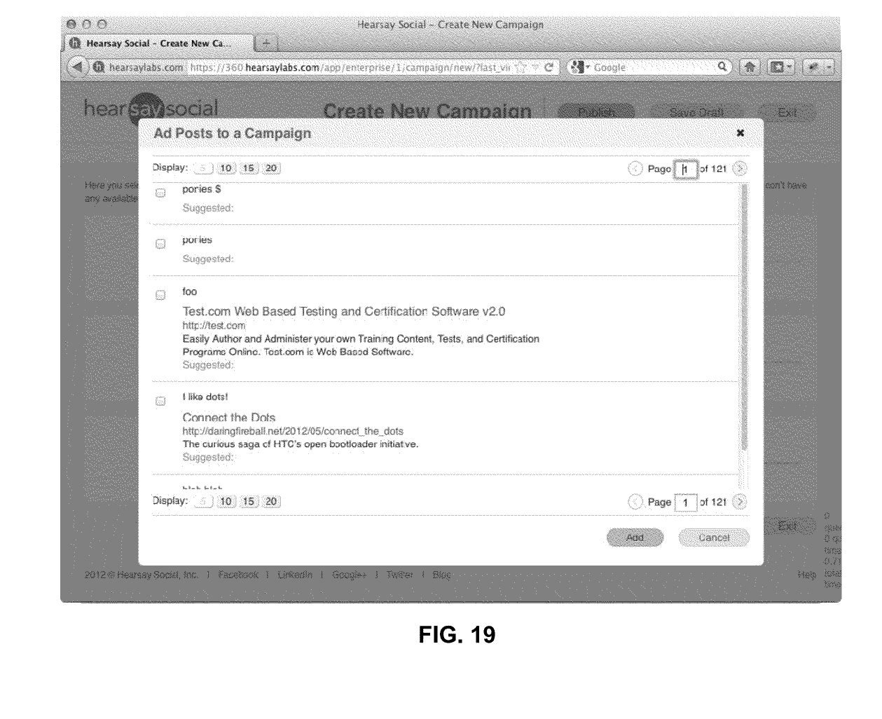

When the publisher clicks on the “Choose Ads” button, the UI screen of FIG. 17 is shown. A list of master ad elements is displayed, and the publisher can select one or more ads to add to the campaign by checking the boxes next to the ads. Similarly, when the publisher clicks on “Choose Apps” or “Choose Posts,” the UI screens of FIG. 18 or 19 are invoked to display master apps or master posts, respectively, for the publisher to make selections and add elements to the campaign.

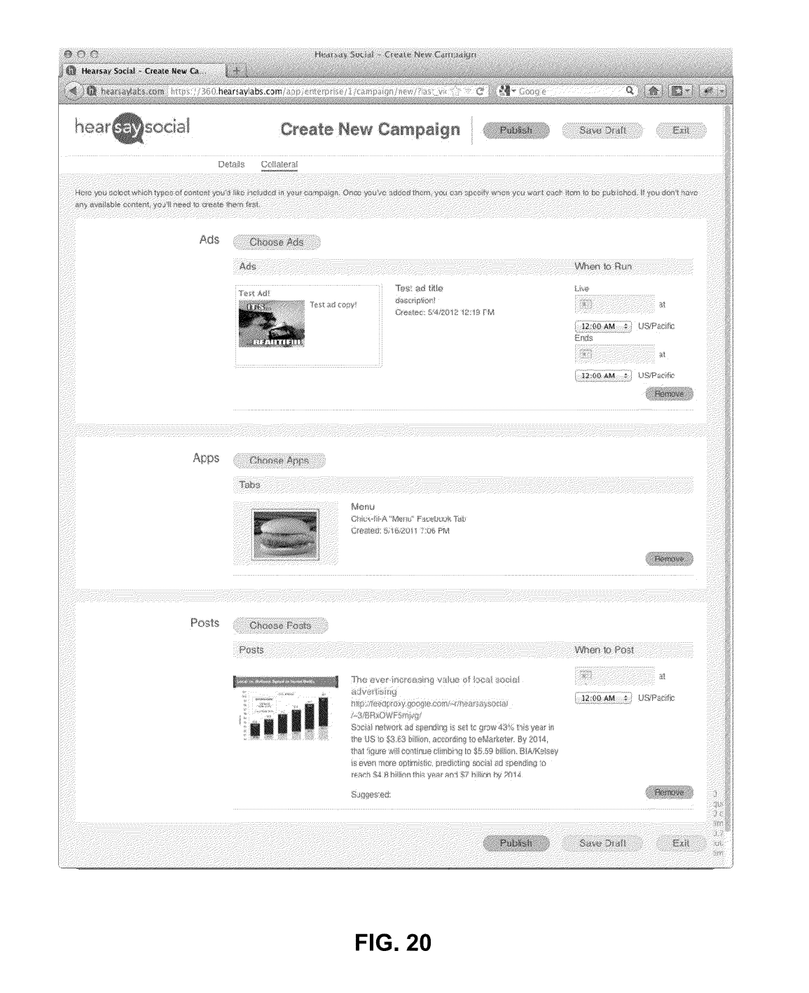

FIG. 20 illustrates an example screen displaying a configured campaign, in which ads, apps, and posts are populated with selected publishable elements. The publisher can add or remove elements to the campaign, save a draft of the campaign by clicking the “Save Draft” button, or publish the campaign by clicking the “Publish” button.

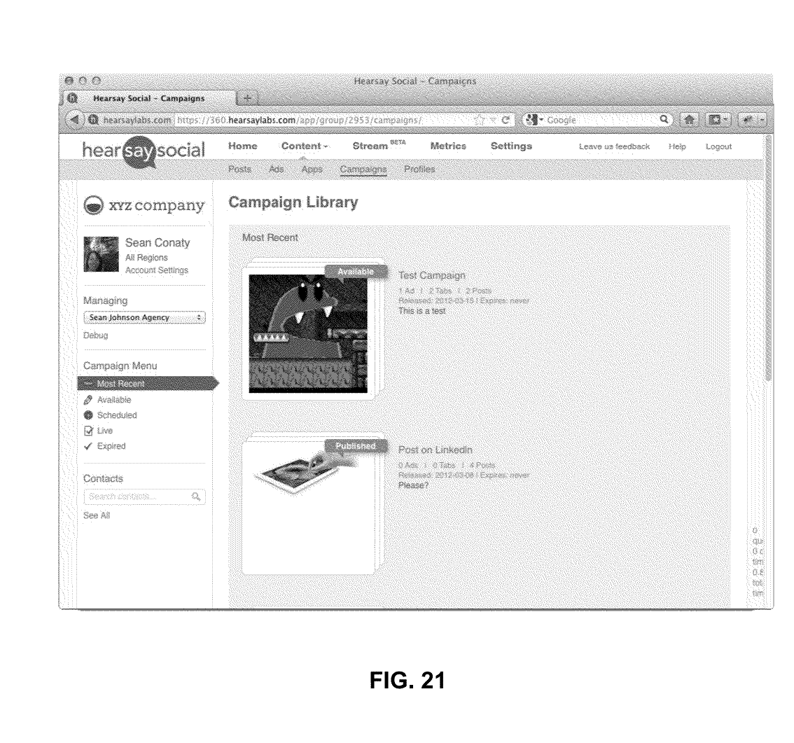

Once “Save Draft” is clicked, a draft of the campaign is saved in the library and shown as available for publishing (as shown in FIG. 21.)

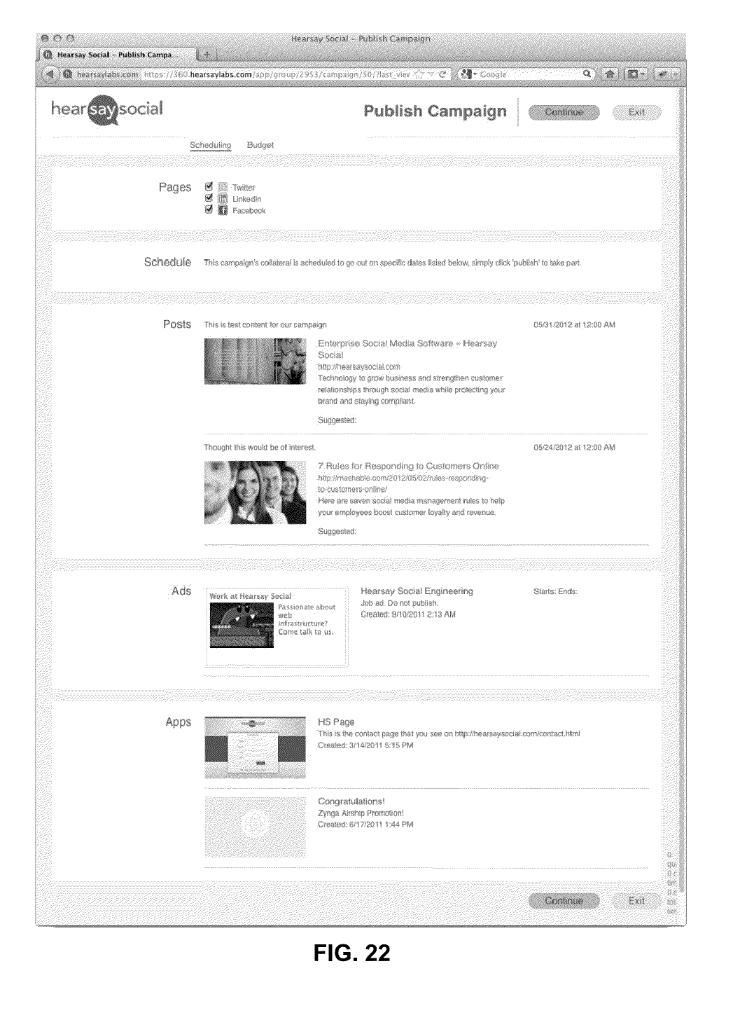

In this example, once “Publish” is clicked, the publisher is led to additional publication configuration screens to configure the publication options for the campaign. In some embodiments, the publication options can be configured prior to the publisher selecting the “Publish” button. FIG. 22 shows the scheduling options, where the publisher can configure to which social media platforms the campaign should be published, and optionally select the start and end time for showing the selected elements. The timing for publishing an element can be absolute (e.g., on Jan. 1, 2012 at 5 pm), or relative (e.g., the second element is published 5 days after the first element is published). In some embodiments, the publisher application includes connectors that verify and format the campaign elements and transfer the formatted data to the preconfigured social networking assets. For example, if the number of characters in a post exceeds what is allowed on a social media platform, the publisher application can divide the post into multiple posts that do fulfill the length requirement, omit the post, or take other appropriate actions.

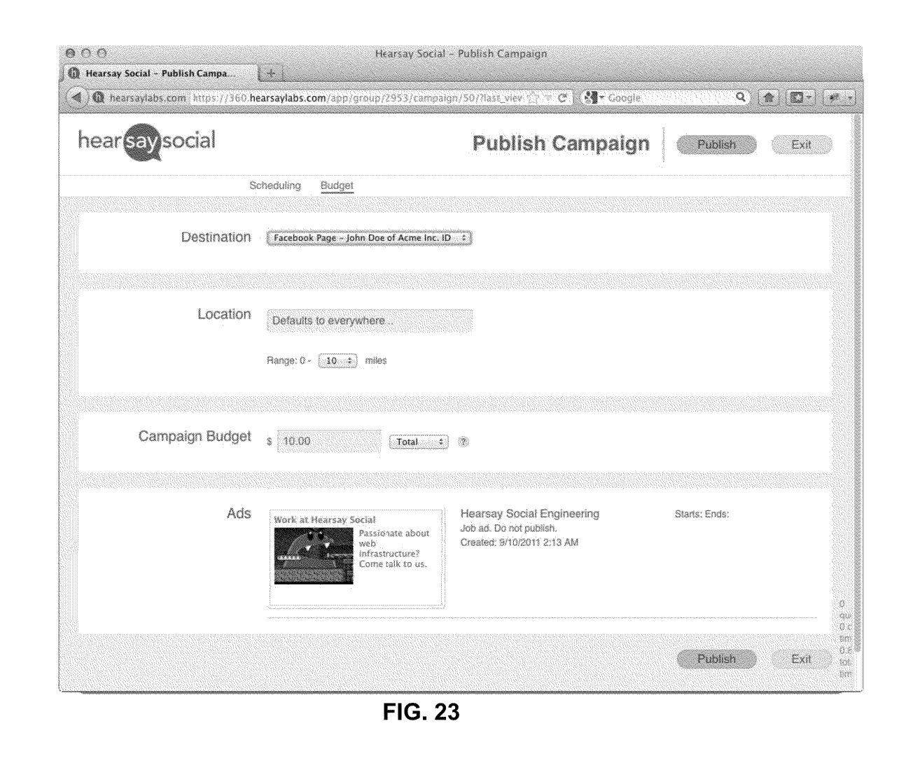

FIG. 23 shows the budget configurations for an ad element. The publisher can select the destination to which the ad elements are published (e.g., John Doe's Facebook® page, LinkedIn® account, etc.), set the budget for the campaign, as well as other optional parameters relating to the ad and affecting the budget (e.g., the area/location of the users on the social media platforms that the ad will attempt to target, since an ad targeting a greater area tends to cost more.) In some embodiments, the budget is controlled by using the advertising APIs provided by the social media platforms and setting the budget limit on the social media platform; in some embodiments, the budget is controlled by the publisher application itself (e.g., if there are 3 ads in a campaign, the publisher application can divide the budget into three portions, where each ad is only allocated a portion of the budget.) Clicking the “Publish” button at this stage will cause the publishable elements to be sent to the configured social media platforms (specifically, to the social media assets associated with the publisher), and the campaign will run according to the specified schedule and budget. Although this example illustrates the configuration of ads, the budget for other types of publishable elements that cost money to publish on the social media platform (such as sponsored stories) can be set in a similar way.

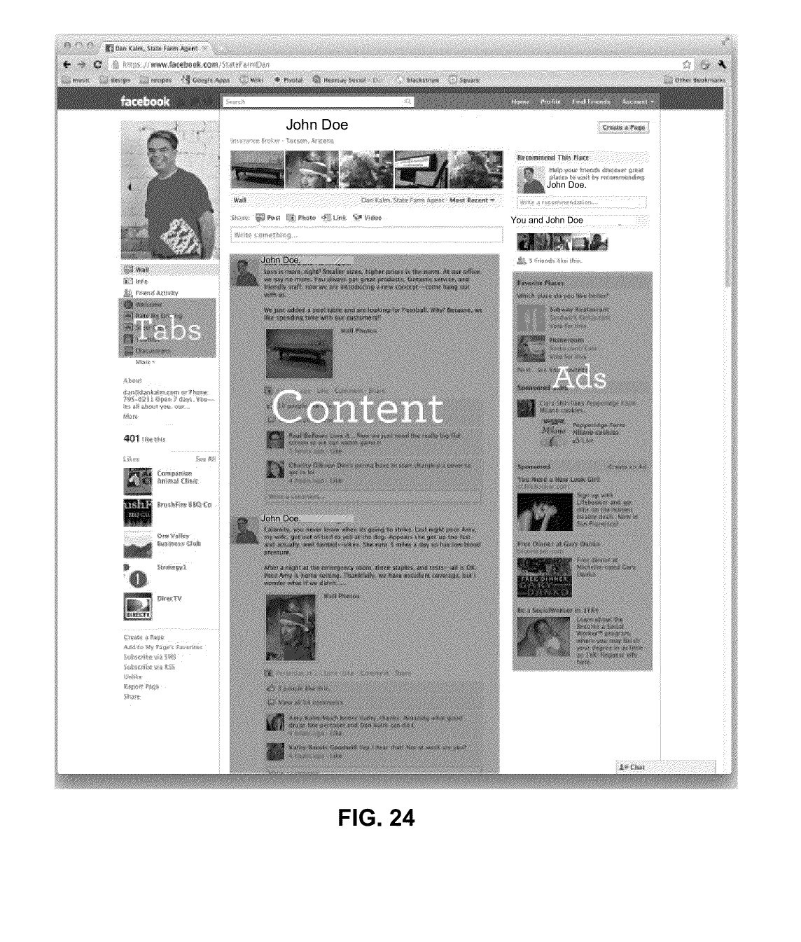

FIG. 24 is an example of a social media asset on which the campaign is published. In this case, the social media asset is a Facebook® page for John Doe. At their designated time, the post elements of the campaign are published to the Content portion of the page; the application elements of the campaign are published in the Tabs (apps) portion of the page; and the ad elements of the campaign are published in the Ads portion of the page.

In some embodiments, once a publisher has created a campaign, a notification is sent to other publishers in the same organization to let them know that a new campaign has been created. Since the campaigns are stored in a central location, the other publishers can select the existing campaign and reuse it (i.e., publish the campaign to the social media assets associated with these publishers).

### Integrated Social Campaign

In the above examples, the publishable elements included in a campaign are selected and published by the same user (e.g., the publisher). In some embodiments, the campaign management platform offers an integrated social campaign feature (also referred to as “campaign in a box”), where a number of campaign elements such as applications, posts, ads, blogs, etc. are preconfigured by the first user (e.g., the campaign creator, who may or may not be the same user as the creator of the individual elements), packaged as a single integrated campaign, and are caused to be published by one or more different users (e.g., publishers). In some embodiments, the first user pre-specifies targeting and timing, and stages campaign rollouts for ease of deployment. A publisher can select the campaign, optionally customize certain elements, and launch the campaign such that the campaign elements are deployed in a coordinated fashion. In some embodiments, the publisher can omit customization and launch the campaign in its default mode, with as little input as a single click.

For example, a campaign creator working for a corporate marketing department creates an integrated campaign where winners of a contest get free blimp rides. The campaign creator builds a landing webpage on the company's website announcing the “win a ride” contest, inviting visitors of the page to enter their personal information in exchange for chances to enter the contest. The campaign creator can create a Facebook® post or a Twitter® tweet that includes a URL to the landing page, a Facebook® app that integrates the landing page as a mini-web application, an ad that targets people with a certain profile, as well as other campaign elements such as deals, blog posts, reviews, etc., and integrate the campaign elements into a single campaign using UI provided by the creator application. The campaign creator can also specify timing of the campaign elements. The timing may be time/schedule-based as well as event-based. For example, the post is configured to run as soon as the campaign is launched by the publisher, and the ad is configured to run at the same time. When the date of the drawing approaches, a reminder is posted. Once the winner is announced, a deal for the company's products is sent to all the participants. Some of the elements (or aspects of the elements) are customizable by the publisher. For example, the publisher may choose how much money to spend on the ads, how frequently the ad should run, etc.

In some embodiments, once an integrated campaign is created, a notification is sent to publishers of the organization so that they become aware of the campaign and can choose to publish the campaign.

### Compliance and Auditing

In some embodiments, campaign elements customized by the publisher are audited for compliance (e.g., by a corporate auditor who may or may not be the same person as the publishable element creator) before they are published. For example, certain business rules are applied, such as prohibition of certain sensitive words and phrases (e.g., profanity, “investment,” “insurance,” “guarantee”), confidential information (e.g., social security numbers, account numbers), etc. A business rule can be implemented as a function performing a regular expression check or the like. When an element is created or modified, the business rule (e.g., function) is invoked, and the element is checked against the rule. In some embodiments, customized elements that violate the rules are rejected. In some embodiments, the customized elements are saved, flagged, and presented to an authorized auditor, who makes a determination of whether to allow them.

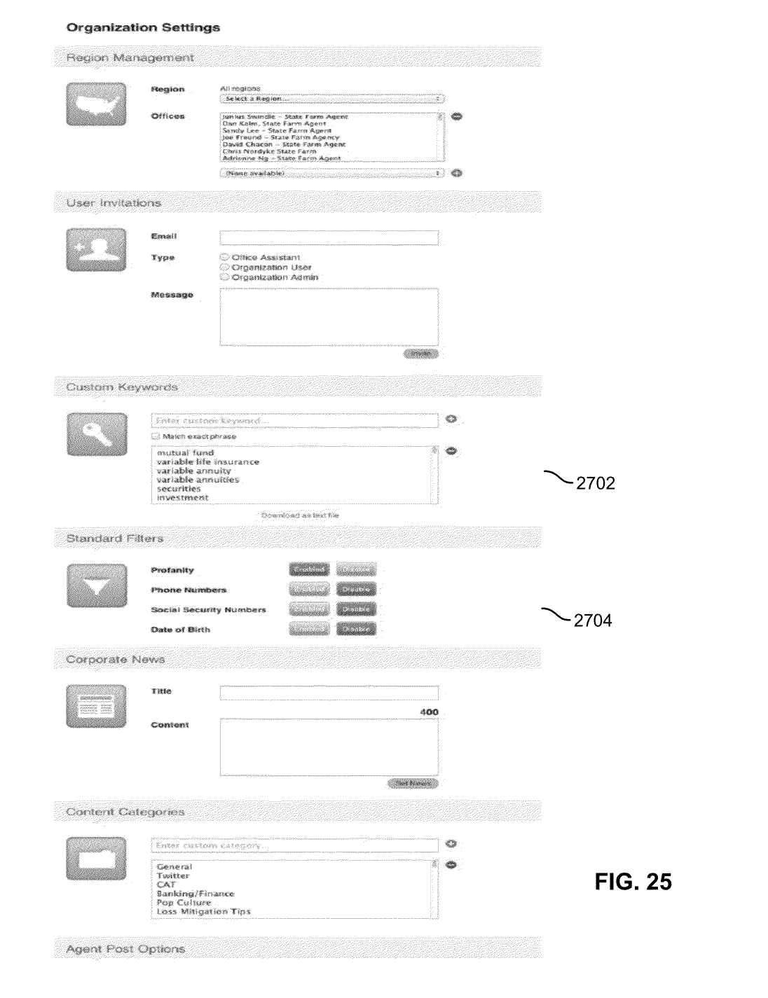

FIG. 25 is an example screen showing audit settings. The auditor is provided with UIs to set regional management settings, customize keywords, filters, configure content categories, etc. In the example shown, the auditor has the option to enter in watched keywords in area 2702, such that matching keywords in the publishable elements (either entered in by the creator or modified by the publisher) are flagged for review and blocked from being published. The auditor also has the option to enable/disable filters such as profanity and sensitive information such as phone numbers, social security numbers, date of birth, etc. in area 2704. These filters are another type of business rule where information included in the publishable elements that match the formats specified by these filters are flagged and blocked.

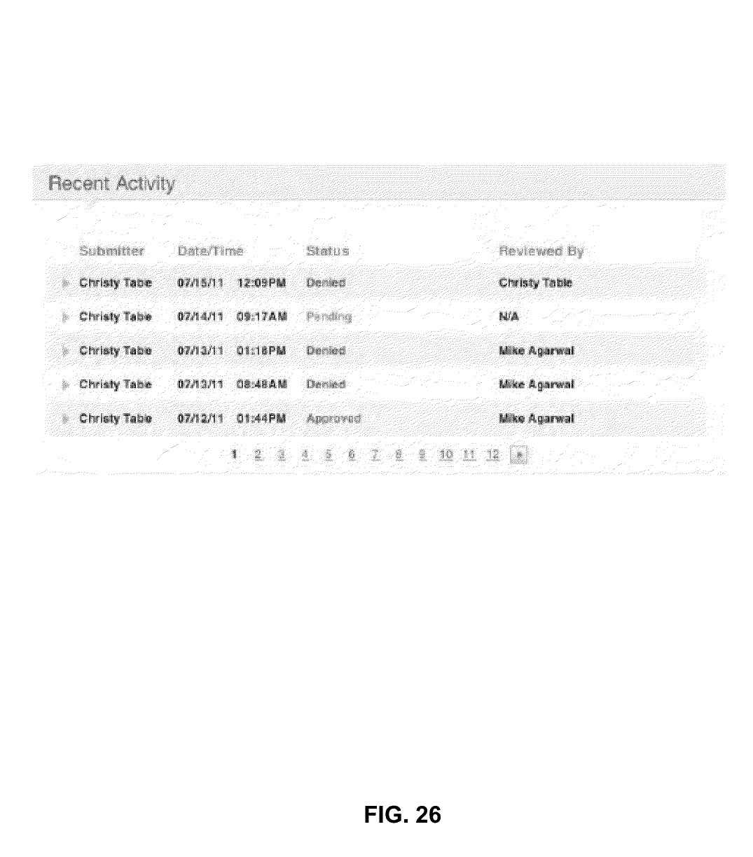

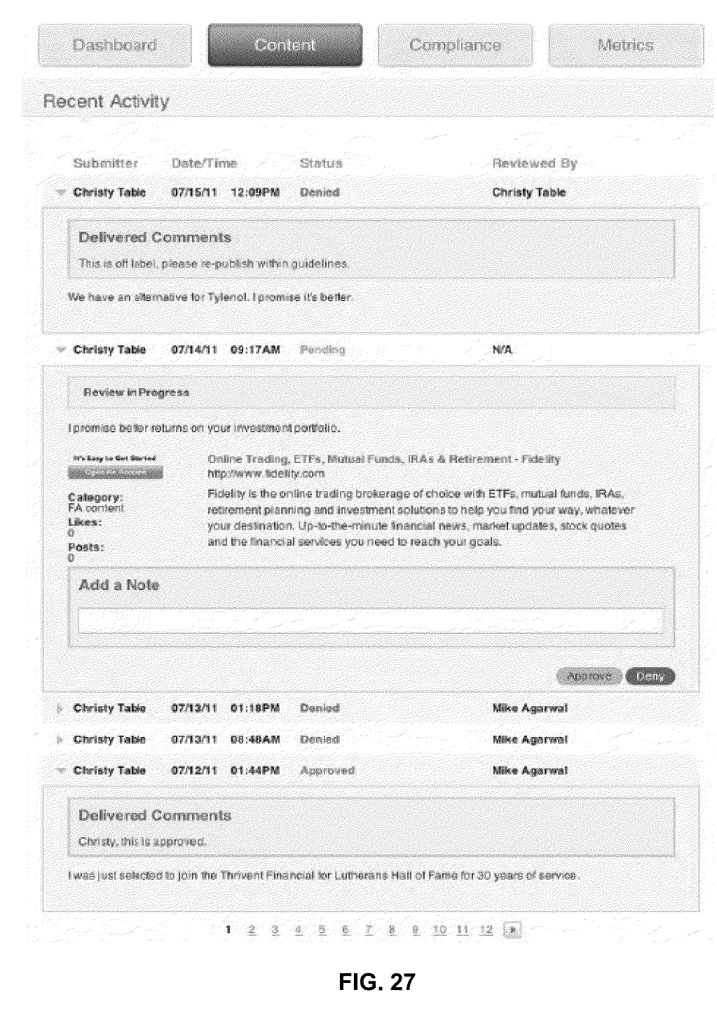

FIGS. 26-27 are example screenshots illustrating results of the compliance approval process. In FIG. 26, recent activities (such as editing a post element in a campaign) by publishers are monitored and displayed to the auditor. If a business rule is triggered, publication is blocked and the activity becomes pending, and the manager can review the pending activity and make a determination on whether the activity should be approved. In FIG. 27, the content of the pending publishable element is displayed. In some embodiments, the reason for making the publishable element pending is also displayed. The auditor has the option to add a note (e.g., suggestions for how to edit the content such that it does not violate company policies), which is saved for the publisher to review.

### Feedback

In some embodiments, feedback is provided to improve the company's marketing effort. In some embodiments, the campaign results (such as conversion statistics measuring how many targeted users made purchases or signed up for accounts, click-through statistics measuring the number of views certain content received) are monitored for feedback purposes. For example, the publisher application or another application can be scheduled to run periodically and collect campaign results from the social media assets to which the content is published. Successful campaigns (e.g., meeting a certain conversion rate or click-through rate) may be repeated while unsuccessful campaigns may be stopped early and/or trigger alternative campaigns. Further, the publisher can request the creator to generate more campaigns, provide certain types of content, etc.

Managing social media network-based marketing campaign has been described. The techniques described herein make it easier to curate the content in the campaign and publish the content to social media network platforms.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for managing social network-based marketing campaigns, comprising: one or more computer processors to:
obtain a social media network-based marketing campaign and configuration information associated with the social media network-based marketing campaign; wherein:
the social media network-based marketing campaign comprises a plurality of selected publishable elements that are selected from a collection of master publishable elements;
a master publishable element is publishable on a social media platform; and
the configuration information at least includes information on how the plurality of selected publishable elements are to be published on the social media platform; and
is publish the plurality of selected publishable elements on the social media platform, according to the configuration information; and
one or more memories coupled to the one or more computer processors, to provide the one or more computer processors with instructions.

2. The system of claim 1, wherein obtaining the social media network-based marketing campaign and configuration information associated with the social media network-based marketing campaign includes:
presenting at least some of the collection of master publishable elements;
receiving selection information of the plurality of selected publishable elements;
presenting a configuration option to configure the social media network-based marketing campaign; and
receiving the configuration information.

3. The system of claim 1, wherein the collection of master publishable elements includes one or more of: an advertisement, a post, a tweet, a sponsored story, an application, a blog post, a deal, and a message.

4. The system of claim 1, wherein the configuration information includes scheduling information of when to publish the selected published elements.

5. The system of claim 1, wherein the configuration information includes information about a condition that, when met, causes a selected publishable element to be published.

6. The system of claim 1, wherein the configuration information includes budget information.

7. The system of claim 1, wherein the selected publishable elements are selected by a first user and are caused to be published by a second user.

8. The system of claim 1, wherein the selected publishable elements are selected by a user and are caused to be published by the same user.

9. The system of claim 1, wherein the social media network-based marketing campaign is associated with a target region.

10. The system of claim 1, wherein the social media network-based marketing campaign is associated with an effective period.

11. The system of claim 1, wherein the one or more computer processors are further to publish the plurality of selected publishable elements on a second social media platform.

12. The system of claim 1, wherein a master publishable element includes existing published content that is identified as popular.

13. The system of claim 1, wherein the plurality of selected publishable elements is published on a plurality of social media platforms.

14. The system of claim 1, wherein publishing the plurality of selected publishable elements on the social media platform includes sending the plurality of selected publishable elements to the social media platform, and making the plurality of selected publishable elements visible to other users on the social media platform.

15. The system of claim 1, wherein publishing the plurality of selected publishable elements on the social media platform includes executing a publishing application programming interface (API).

16. The system of claim 1, wherein the one or more processors are further to send a notification to additional users indicating that the social media network-based marketing campaign is available to be published.

17. The system of claim 1, wherein the one or more processors are further to audit the plurality of selected publishable elements prior to publishing the plurality of selected publishable elements.

18. The system of claim 17, wherein auditing the plurality of selected publishable elements includes:
determining whether a modified selected publishable element violates a rule; and
in the event that it is determined that the modified selected publishable element violates the rule, blocking the plurality of selected publishable elements.

19. The system of claim 1, wherein the one or more processors are further to monitor results of the social media network-based marketing campaign.

20. A method of managing social network-based marketing campaigns, comprising:
obtaining, using one or more computer processors, a social media network-based marketing campaign and configuration information associated with the social media network-based marketing campaign wherein:
the social media network-based marketing campaign comprises a plurality of selected publishable elements that are selected from a collection of master publishable elements;
a master publishable element is publishable on a social media platform; and
the configuration information at least includes information on how the plurality of selected publishable elements are to be published on the social media platform; and
publishing the plurality of selected publishable elements on the social media platform, according to the configuration information.

21. A computer program product for managing social network-based marketing campaigns, the computer program product being embodied in a tangible computer readable storage medium and comprising computer instructions for:
obtaining, using one or more computer processors, a social media network-based marketing campaign and configuration information associated with the social media network-based marketing campaign wherein:
the social media network-based marketing campaign comprises a plurality of selected publishable elements that are selected from a collection of master publishable elements;
a master publishable element is publishable on a social media platform; and
the configuration information at least includes information on how the plurality of selected publishable elements are to be published on the social media platform; and
publishing the plurality of selected publishable elements on the social media platform, according to the configuration information.
